(19) United States
(12) Patent Application Publication
(10) Pub. No.: US 2024/0370731 A1
(43) Pub. Date: Nov. 7, 2024

(54) UNSUPERVISED MODEL DRIFT ESTIMATION SYSTEM FOR DATASET SHIFT DETECTION AND MODEL SELECTION

(71) Applicant: Intel Corporation, Santa Clara, CA (US)

(72) Inventors: Seok-Yong BYUN, Seoul (KR); Minje PARK, Seongnam-si, Gyeonggi-do (KR); Kirill CHECHIL, Nizhny Novgorod (RU); Wonju LEE, Seongnam-si, Gyeonggi-do (KR)

(73) Assignee: Intel Corporation, Santa Clara, CA (US)

(21) Appl. No.: 18/573,527

(22) PCT Filed: Nov. 3, 2021
(86) PCT No.: PCT/KR2021/015819

§ 371 Date: Dec. 22, 2023

(51) Int. Cl. G06N 3/088; G06N 3/045

(52) U.S. Cl. CPC G06N 3/088; G06N 3/045

(57) ABSTRACT

Systems, apparatuses and methods include technology that identifies a first neural network, wherein the first neural network is associated with a first training parameter and first population data that are generated during a process to train the first neural network. The technology executes a first neural network process to serve input data with the first neural network, and estimates a first drift of the first neural network based on the first neural network process, the first training parameter and the first population data to determine whether to retrain the first neural network.

### TECHNICAL FIELD

Embodiments generally relate to estimating the discrepancy of a model from target datasets based on a first training parameter and first population data. The discrepancy may correspond to a Model Drift Estimation (MDE) that effectively estimates the test error with a single forward pass in an unsupervised manner.

### BACKGROUND

Some data streams may change frequently in a non-stationary way. Some deep learning methods optimize neural networks on training data, and the changing frequency of the data streams leads to severe performance degradation in real-world applications. It may be difficult to annotate newly streamed data or include consistent inspection by a human to detect such shifts. Thus, detecting model drift may be problematic, and may lead to degradation of neural network analysis and output.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram of an example of a drift estimation process according to an embodiment;

FIG. 2 is a flowchart of an example of a method to estimate a drift of a neural network according to an embodiment;

FIG. 3 is a diagram of an example of training and deploying a neural network based on a drift estimate according to an embodiment;

FIG. 4 is a diagram of an example of training and deploying a neural network based on a drift estimate according to an embodiment;

FIG. 5 is a diagram of an example of selecting and deploying one of a first neural network and a second neural network according to an embodiment;

FIG. 6 is a flowchart of an example of a method of selecting a neural network for deployment according to an embodiment;

FIG. 7 is a flowchart of an example of a method of retraining a deployed neural network according to an embodiment;

FIG. 8 is a block diagram of an example of drift estimation computing system according to an embodiment;

FIG. 9 is an illustration of an example of a semiconductor apparatus according to an embodiment;

FIG. 10 is a block diagram of an example of a processor according to an embodiment; and

FIG. 11 is a block diagram of an example of a multi-processor based computing system according to an embodiment.

### DESCRIPTION OF EMBODIMENTS

Some embodiments measure the model drift between a deployed neural network model and a streamed input data in an unsupervised manner. Model drift arises from a difference of distributions between a source dataset and a target dataset (e.g., the model is trained on the source dataset, but the model is deployed on the target dataset). That is, the neural network may be trained to operate on a source dataset and generate accurate results (e.g., classification) based on the source dataset. The neural network may then be deployed and/or tested to process a target dataset that is different from the source dataset. If the target dataset is significantly different from the source dataset, the neural network may provide inaccurate results since the neural network may be unable to properly process the target dataset.

Some embodiments may also predict test error based on model drift to select a most effective (or best initialized) model among multiple models in a model-zoo or training trajectories. Other implementations may inefficiently simply rely on accuracy metrics (e.g., Accuracy, Precision, Recall, F1 Score metrics, etc.) that are based on labelled data for estimating model drift and selecting models with the assumption that source data has annotation (i.e., is labeled). Some embodiments as described herein include a model drift estimation method that is executed based on the statistics of a neural network layer (e.g., batch normalization layer) in an unsupervised manner, which may be used in applications related to dataset shift detection and model selection.

Thus, some embodiments provide a method for estimating such dataset shift in an unsupervised way, and is far more robust as compared to many existing supervised dataset shift estimation methods. For example, batch normalization (BN) layer preserves the statistics of training data on both learnable parameters and running estimates that are generated during training. As will be explained below, the statistics of the BN layers may be used to estimate the discrepancy of the model from target datasets. MDE methods as described herein may effectively estimate the test error with a single forward pass in an unsupervised manner.

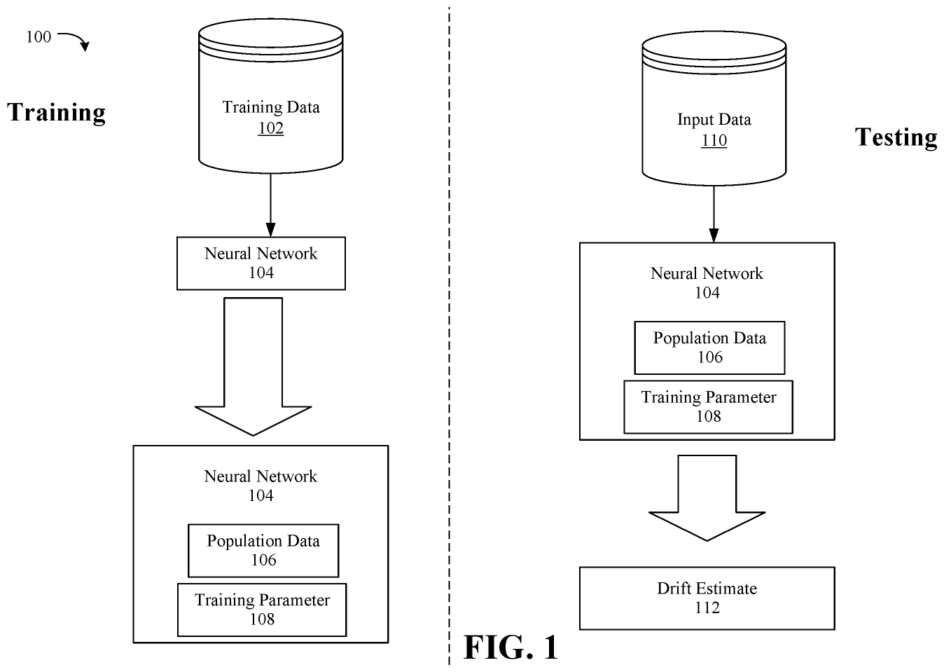

Turning now to FIG. 1, a drift estimation process 100 for estimating dataset shift is illustrated. In FIG. 1, the neural network 104 (e.g., a first trained neural network model) executes a training process based on the training data 102 to generate population data 106 and training parameter 108. Thus, the neural network 104 is associated with the training parameter 108 and the population data 106 that are generated during training the neural network 104.

For example, the neural network 104 may include a plurality of BN layers. A BN layer may execute BN operations to smooth the solution space during optimizing deep neural operations by normalizing each input feature within a mini-batch to have a zero-mean and unit-variance. Hence, neural network 104 includes BN layers to achieve a gain of stability and convergence speed (e.g., especially for visual tasks).

For example, a BN layer may be inserted between a first hidden layer of the neural network 104, and a following second hidden layer of the neural network 104. The neural network 104 may receive outputs from the first hidden layer and normalize them before passing them on as the input of the next hidden layer. Batch normalization is a mechanism that aims to stabilize the distribution (over a minibatch) of inputs to a given network layer during training. This is achieved by augmenting the network with batch normalization layers that set the population data 106 (e.g., a first two moments including mean and variance). Then, the batch normalized inputs are also scaled and shifted based on trainable parameters to preserve model expressivity.

Batch normalization may include multiplying the normalized values by a factor, gamma (a learned parameter during training), and adding to it a factor, beta (a learned parameter during training). In order to do so, two learnable parameters called beta and gamma, and moving average parameters are determined and tracked. Batch normalization allows values to be shifted (to a different mean) and scaled (to a different variance). Additionally, batch normalization also keeps a running count of the Exponential Moving Average (EMA) of the mean and variance. During training, batch normalization may calculate the EMA but does not take action based on the EMA. At the end of training, the batch normalization saves the mean and variance as part of the BN layer's state, for use during the Inference phase.

In some embodiments as described herein, the process 100 includes input data 110 that defines the input feature vector of mini-batch n as xⁿ=[x₁ⁿ; x₂ⁿ; . . . ; x_{C}ⁿ] with the number C of channels. A BN layer normalizes the input feature vector by its stored running estimates, (e.g., running mean μ and running standard deviation σ), and the BN layer outputs the normalized signal by multiplying γ and adding β to an input vector, and outputting a normalized output vector as defined in Equation 1. An example of batch normalization during training is provided by Equation 1 below:

$${y}_{c}^{n} = γ \frac{{x}_{c}^{n} - {μ}_{c}}{{σ}_{c}} + β \qquad Equation 1$$

In Equation 1, the scale γ and shift β are learnable parameters determined during training and running estimates p and a are calculated following exponential moving average during the training phase. x_{c}ⁿ may be an input vector and y_{c}ⁿ may be an output vector.

After training, the neural network 104 undergoes testing to determine whether the neural network 104 will be effective if deployed. The testing includes executing a first neural network process based on the input data 110 (e.g., a target dataset) with the neural network 104, and determining a drift estimate 112 (e.g., an estimate of the drift which may be a numerical value) of the neural network 104 based on the neural network process, the training parameter 108 and the population data 106. For example, each BN layer may standardize the inputs to a following layer for each mini-batch based on Equation 2 below:

$$y = γ \frac{x - \overline{μ}}{{\overline{σ}}^{2}} + β \qquad Equation 2$$

Therefore, the drift estimate 112 may also be based on an input vector (x in Equation 2) to a batch normalization layer and an output vector (y in Equation 2) from the batch normalization layer. The output vector may be generated based on the training parameter 108 and the population data 106. For example, a distance between the output vector and the input vector may be calculated and form part of the drift estimate 112. For each batch normalization layer, a distance may be calculated. In Equation 2, average μ̅, and variance σ̅² are minibatch population statistics. Equation 2 may be translated into Equation 3 which is an equivalent form:

$$y = γ \frac{x - \overline{μ}}{{\overline{σ}}^{2}} + β - > \frac{y - β}{γ} = \frac{x - \overline{μ}}{{\overline{σ}}^{2}} \qquad Equation 3$$

Process 100 may calculate a distance for each BN layer that corresponds to the drift estimate 112. For example, the process 100 may calculate a distance for each BN layer according to Equation 4:

$${d}^{( l )} = Dist ( \frac{y - β}{γ} , \frac{x - μ}{{σ}^{2}} ) , \qquad Equation 4$$

In Equation 4, μ and σ² are the mean and variance associated with x and are determined during the testing phase. The distance corresponds to an overall data shift between the training data 102 and the input data 110. In some examples, the distance may be determined in other ways. For example, the distance may be a Cosine distance, Wasserstein distance, Kullback-Leibler divergence, etc.

The overall drift of the deployed model may be provided by Equation 5 below:

$$D = {\sum }_{l} {w}_{l} {d}^{( l )} \qquad Equation 5$$

In Equation 5, wₗ is a weighting parameter and d^{(l)} is a distance of a BN layer. The different distances of the BN layers d^{(l)} are multiplied by weighting parameters wₗ and summed together to calculate the drift estimate 112 (which corresponds to D). Thus, the drift estimate 112 may be a summation of all the distances.

As already described, the scale γ and shift β are learnable parameters and running estimates of the mean p and standard deviation—that are calculated following exponential moving average during the training phase. Thus, we infer that the statistics of the training data 102 are implicitly included in the running estimates and embodiments may measure the model discrepancy by comparing statistics of the training data 102, that are stored in the neural network 104 after training, and statistics of input data 110. As noted, reference to label information is not needed during the comparison of the statistics.

Model drift may originate from the difference of distributions between the training data 102 used during training and the input data 110 processed by the neural network 104. That is, the neural network 104 is deployed on the input data 110 which is distributed differently from the training data 102 that was used to train the neural network 104. To compute the drift estimate 112 (e.g., a model drift score), process 100 may calculate the distance between the training data 102 and the input data 110 without accessing any other information about the training data 102. Some embodiments may do so based on the running estimates stored in the BN layers with the assumption that such running estimates (e.g., p and running standard deviation σ), approximately represent the conditional distribution of the source dataset. From Equation 1, the proposed drift score/estimate of a BN layer may be defined by Equation 6 below

$${d}^{( l )} = \frac{1}{N} \frac{1}{C} {\sum }_{n = 1}^{N} {\sum }_{c = 1}^{C} Dist ( \frac{{x}_{c}^{n , ( l )} - {\overline{μ}}_{c}^{n , ( l )}}{{\overline{σ}}^{n , ( l )}} , \frac{{y}_{c}^{n , ( l )} - {β}^{( l )}}{{γ}^{( l )}} ) \qquad Equation 6$$

In Equation 6, Dist(a, b) may be any distance metric between feature vectors a and b, μ̅_{c}^{n,(l)} and σ̅_{c}^{n,(l)} are mean and standard deviation of channel l of mini-batch xⁿ, respectively. Due to its changes of mean and variance according to mini-batch as described in Equation 6, the stability of drift score/estimate may be degraded in some contexts. To enhance the stability further, some embodiments may calculate the mean and standard deviation (e.g., μ̅_{c}^{(l)} and σ̅_{c}^{(l)} of overall target datasets, then compute the global statistics of a target dataset of Equation 6 with μ̅_{c}^{(l)} and σ̅_{c}^{(l)} instead of μ̅_{c}^{n,(l)} and σ̅_{c}^{n,(l)}. Such embodiments then turn to calculate μ̅_{c}^{(l)} and σ̅_{c}^{(l)} and finally obtain the drift D from Equation 7 as described below.

From Equation 6, the right most portion of Equation 6

$$( e . g . , \frac{{y}_{c}^{n , ( l )} - {β}^{( l )}}{{γ}^{( l )}} )$$

may implicitly contain the running estimates in the BN layer and the left element

$$( e . g . , \frac{{x}_{c}^{n , ( l )} - {\overline{μ}}_{c}^{n , ( l )}}{{\overline{σ}}^{n , ( l )}} )$$

contains the information of the input data 110 (e.g., target dataset). Thus, embodiments may implicitly compute the distance of the training data 102 from the input data 110. Some embodiments may define the drift estimate 112 (e.g., an overall model discrepancy) by taking the average of all BN layers of the neural network 104 by Equation 7:

$$D = \frac{1}{L} {\sum }_{l = 1}^{L} {w}^{( l )} {d}^{( l )} \qquad Equation 7$$

In Equation 7, weight w^{(l)}∈[0,1] indicates the relative importance of BN layer l compared to others. Different methods may measure the importance. For instance, importance per layer may be defined as the size of gradient during training phase, but may be simply set this to 1 for all layers. In Equation 7, the distance D may be an average of all model drifts of the BN layers (e.g., a summation of Equation 6 for each BN layer), and may the set as the drift estimate 112.

Some embodiments suppose that input feature vector at a BN layer l is independent and identically distributed (“i.i.d.”) random variable following Gaussian distribution with mean μ̅_{c}^{(l)} and standard deviation σ̅_{c}^{(l)}. Then the left term of Equation 6 follows Gaussian distribution with zero-mean unit-variance, while the right term of Equation 6 is shown by Equation 8:

$$\frac{{y}_{c}^{n , ( l )} - {β}^{( l )}}{{γ}^{( l )}} ∼ N ( \frac{{\overline{μ}}^{( l )} - {μ}_{c}^{( l )}}{{σ}_{c}^{( l )}} , {( \frac{{\overline{σ}}^{n , ( l )}}{{σ}_{c}^{( l )}} )}^{2} \qquad Equation 8$$

In some embodiments, the drift score/estimate in Equation 6 or drift estimate 112 may be approximated into a comparison of the distances between two random variables following Gaussian distribution, and the distance metric is simplified to the Wasserstein distance as follows in Equation 9:

$${d}^{( l )} \approx \frac{1}{C} {\sum }_{c = 1}^{c} ( \frac{{( {\overline{μ}}_{c}^{( l )} - {μ}_{c}^{( l )} )}^{2} + {( {\overline{σ}}_{c}^{( l )} - {σ}_{c}^{( l )} )}^{2}}{{( {σ}_{c}^{( l )} )}^{2}} ) \qquad Equation 9$$

Equation 9 may also be replaced by a Jensen-Shannon divergence or statistical z-test based distance. Without an assumption that input feature vector is i.i.d., Gaussian random variable, the drift score/estimate of Equation 6 of a BN layer may be computed with conventional distance metrics such as cosine distance provided by Equation 10 below:

$$CosDist ( a , b ) = ( 1 - a \cdot b / ‖ a ‖ ‖ b ‖ ) / 2 \qquad Equation 10$$

Equation 10 is bounded between a range of [0, 1]. By noting that the relative scale of the drift score/estimate is important for the purposes of both shift detection and model selection, some embodiments fix the distance metric of Equation 9 that do not include the rank order (e.g., to are concentrating the relative scale to obtain the rank of models instead of absolute scale). and may later select the cosine distance as a distance metric without assuming i.i.d. cases. In detail, the drift score/estimate according to Equation 9 may have a discriminating value to that of an identical case that causes shift detection problems and may be used to separate the quality of models for transferring in model selection problems.

Thus, process 100 does not require reference to labelled data to determine drift estimate 112. Rather, the distances may serve as an indicator of drift without requiring manual annotation and enhancing efficiency. In some embodiments, the process 100 may include determining whether to retrain the neural network 104 based on the drift estimate 112. In some embodiments, the process 100 may include determining whether to deploy the neural network 104 or bypass deployment of the neural network 104. For example, if the drift estimate 112 meets a threshold, the neural network 104 may be retrained. If the drift estimate 112 does not meet a threshold, the neural network 104 may be deployed. In some examples, the drift estimate 112 may be used to determine whether to select the neural network 104 for further training and deployment, or another network for training and deployment.

A low-rank approximation is now described. It is worth noting that a BN operation that multiplies y and adds p may amplify and propagate the unnecessary details or fluctuations across batches, and possibly deteriorates the stability of drift measurement. By applying a low-rank approximation (e.g., Singular Value Decomposition), some embodiments may increase the stability of MDE, particularly for cases when the neural network 104 and the input data 110 have a small domain discrepancy.

The drift estimate described above may generally correspond to data shifts between the training data 102 and the input data 110 as a whole, rather than on a datapoint by datapoint basis. That is, the entire distribution of the training data 102 is effectively compared to the distribution of the input data 110 and take action based on the drift estimate 112.

Some or all components in the process 100 may be implemented using one or more of a CPU, a GPU, an AI accelerator, a FPGA accelerator, an ASIC, and/or via a processor with software, or in a combination of a processor with software and an FPGA or ASIC. More particularly, components of the process 100 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality logic hardware using circuit technology such as, for example, ASIC, complementary metal oxide semiconductor (CMOS) or transistor-transistor logic (TTL) technology, or any combination thereof.

For example, computer program code to carry out operations by the process 100 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

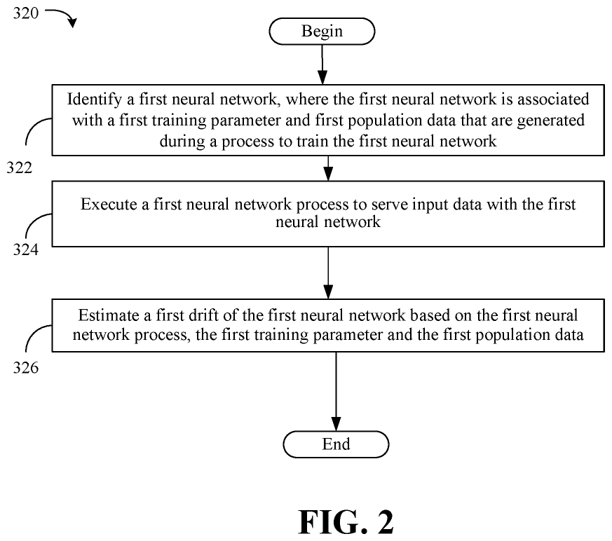

FIG. 2 shows a method 320 to estimate a drift of a neural network. The method 320 may be readily combinable with any of the embodiments described herein. For example, the method 320 may implement and/or operate in conjunction with one or more aspects of the process 100 (FIG. 1) already discussed. The method 320 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 322 identifies a first neural network, where the first neural network is associated with a first training parameter and first population data that are generated during a process to train the first neural network. Illustrated processing block 324 executes a first neural network process to serve input data with the first neural network. Illustrated processing block 326 estimates a first drift of the first neural network based on the first neural network process, the first training parameter and the first population data. In some embodiments, method 320 includes determining a plurality of distances for a plurality of layers of the first neural network based on the first neural network process, the first training parameter and the first population data, and estimating the first drift based on the plurality of distances.

In some embodiments, method 320 includes identifying a second neural network, where the second neural network is associated with a second training parameter and second population data that are generated during a process to train the second neural network. The method 320 includes executing a second neural network process to serve the input data with the second neural network, estimating a second drift of the second neural network based on the second neural network process, the second training parameter and the second population data, and selecting one of the first neural network and the second neural network for deployment based on the first drift and the second drift.

In some embodiments, method 320 includes determining whether to retrain the first neural network based on the first drift. In some embodiments, the first neural network includes a plurality of batch normalization layers, the first training parameter includes a scale parameter and a shift parameter associated with the plurality of batch normalization layers, where the scale parameter and the shift parameter are generated during the process to train the first neural network, and the first population data includes a moving mean and moving standard deviation generated during the process to train the first neural network. In some embodiments, method 320 includes estimating the first drift of the first neural network based on an input vector into a batch normalization layer of the first neural network and an output vector of the batch normalization layer.

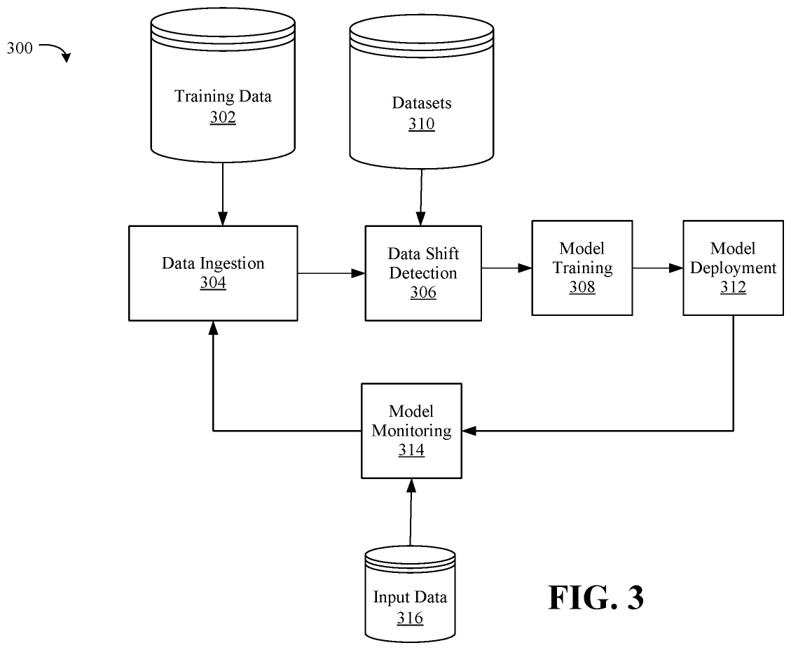

FIG. 3 illustrates a process 300 to train and deploy a neural network. The process 300 may be readily combinable with any of the embodiments described herein. For example, the process 300 may implement and/or operate in conjunction with one or more aspects of the process 100 (FIG. 1) and/or the method 320 (FIG. 2), already discussed. The process 300 may generally be implemented with the embodiments described herein, for example, the process 100 (FIG. 1), already discussed. The process 300 may include determining whether training of a neural network (e.g., a pretrained neural network model) is needed. The process 300 may include data ingestion 304 of the training data 302. Data ingestion 304 accomplishes works related to data filtration and validation such as duplicate-removal, data imbalance ratio check, hierarchical label structure check, etc. A data shift detection 306 detects a data shift between the training data 302 and the datasets 310 based on a drift estimate of the neural network during processing of the datasets 310 as described above. For example, the data shift detection 306 may detect a drift estimate based on the neural network and the datasets 310.

For example, the data shift detection 306 may learn a subset sequentially (e.g., an active learner) of the datasets 310 to generate the drift estimate to determine whether the neural network is to be retrained. If so, a drift flag may indicate whether the neural network is to be retrained. For example, the data distribution may be shifted such as for a train-train skew example. The data shift detection 306 may identify whether a data distributional shift has occurred or not between the training data 302 and the datasets 310. Thus, the data shift detection 306 may determine a drift estimation between the training data 302 and datasets 310 through the neural network. The data shift detection 306 may detect the shift by comparing the estimated drift to a predefined threshold and setting a drift flag if the threshold is met.

The process 300 includes model training 308 to train the neural network if the drift flag is set (e.g., if the estimated drift meets the threshold). If the drift flag is not set, model deployment 312 may deploy the neural network without further training. If the drift flag is set, model training 308 may train the neural network and then model deployment 312 may deploy the neural network that has been further trained. Model monitoring 314 may monitor the neural network model to continuously generate drift estimates based on input data 316. If one of the drift estimates meets a threshold, then the process 300 may repeat with data ingestion 304. In some embodiments, if the drift estimates meets a threshold, the model may be trained with the new data in data ingestion 304 and data shift detection 306 may be bypassed in such an example. Thus, the process 300 determines whether to retrain the trained neural network model based on the drift estimates of the input data.

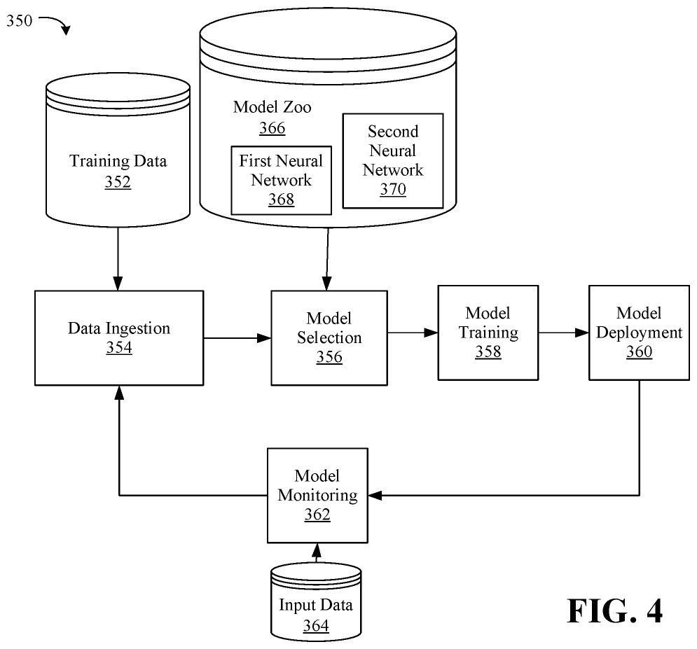

FIG. 4 illustrates a process 350 to select and deploy one of a first neural network 368 or a second neural network 370 from a model zoo 366. The process 350 may be readily combinable with any of the embodiments described herein. For example, the process 350 may implement and/or operate in conjunction with one or more aspects of the process 100 (FIG. 1), the method 320 (FIG. 2), process 300 (FIG. 3), already discussed. Training data 352 may be processed by the data ingestion 354. For example, training data 352 may be processed by the data ingestion 354 with the validation of itself. Model selection 356 then selects one of the first neural network 368 and the second neural network 370 for further training and deployment. For example, the model selection 356 may determine a first drift estimate of the first neural network 368 based on input data, and a second drift estimate of the second neural network 370 based on the same input data.

That is, model selection 356 identifies the first neural network 368 (e.g., a trained neural network) and the second neural network 370 (e.g., a trained neural network). The first neural network 368 is associated with a first training parameter (a scale γ and shift β) and first population data (average μ̅, and variance σ̅² that are minibatch population statistics) that are generated during a process to train the first neural network 368. In some embodiments, each neural network contains each different training parameters and population statistics. The model selection 356 estimates a drift of the first neural network 368 based on the first neural network process, the first training parameter and the first population data.

The second neural network 370 (e.g., trained neural network) is associated with a second training parameter (a scale γ and shift β) and second population data (average μ̅, and variance σ̅² that are minibatch population statistics) that are generated during a process to train the second neural network 370. The model selection 356 estimates a second drift of the second neural network 370 based on a second neural network process to process the input data, the second training parameter and the second population data.

The model selection 356 selects one of the first trained neural network model and the second trained neural network for deployment based on the first drift and the second drift. For example, the model selection 356 may select a selected neural network from the first and second neural networks 368, 370 that has a smallest drift estimate so as to be trained on data that is most similarly distributed to the training data 352.

After the selected neural network is chosen, model training 358 trains the selected neural network. Model deployment 360 deploys the selected neural network. Model monitoring 362 monitors the selected neural network for drift estimates. If one of the drift estimate meets a threshold, data ingestion 354 may re-execute. Notably, another of the first neural network 368 and the second neural network 370 may be selected by model selection 356 in response to the drift estimate meeting the threshold, and based drift estimates calculated based on the input data 364. For example a first updated drift estimate may be calculated for the first neural network 368 and the input data 364, and a second updated drift estimate may be calculated for the second neural network 370 and the input data 364. Model selection 356 may select one of the first and second neural networks 368, 370 based on the first updated drift estimate and the second updated drift estimate. Thus, the selected neural network model may be changed depending on the input data 364 that is currently being processed.

Each of the first neural network 368 and the second neural network 370 includes a plurality of BN layers. In some embodiments, the first and second drifts may be further generated based on input vectors and output vectors into BN layers as described above.

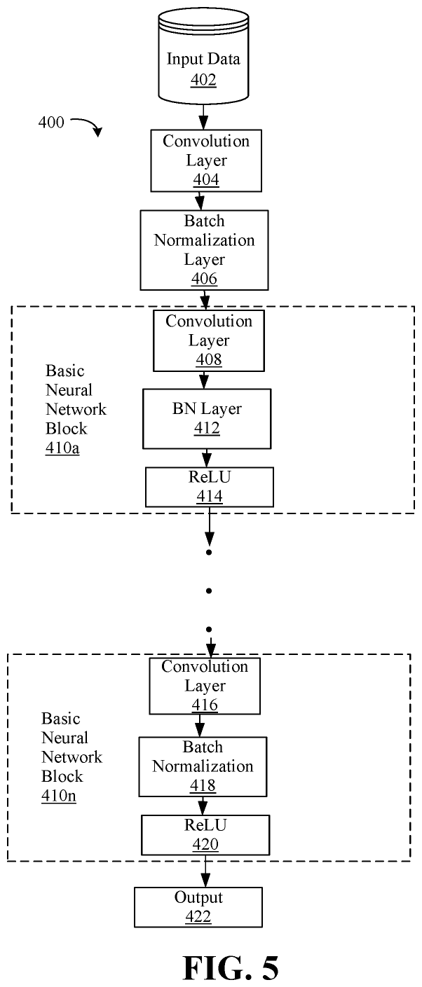

FIG. 5 illustrates a neural network architecture 400 that processes input data 402. The neural network architecture 400 may be readily combinable with any of the embodiments described herein. For example, the neural network architecture 400 may implement and/or operate in conjunction with one or more aspects of the process 100 (FIG. 1), the method 320 (FIG. 2), process 300 (FIG. 3), and/or process 350 (FIG. 4) already discussed. The neural network architecture 400 includes a convolution layer 404 and a BN layer 406. That process the input data 402. The neural network architecture 400 includes a plurality of basic neural network blocks 410a-410n. The basic neural network block 410a includes a convolution layer 408, BN layer 412 and Rectified Linear Unit 414 (ReLU). Activations may first be processed by convolution layer 408, which provides a first output (based on the activations) to the BN layer 412. The BN layer 412 may receive the first output, process the first output and generate a second output based on the first output. The ReLU 414 may receive the second output, process the second output and generate a third output based on the second output. The third output may be provided to a following one of the plurality of basic neural network blocks 410a-410n. Each of the plurality of basic neural network blocks 410a-410n is similarly formed. For example, the basic neural network block 410n includes a convolution layer 416, BN layer 418 and ReLU 420 that generate output 422.

Some embodiments may detect and estimate drift of the neural network architecture 400 based on the BN layers 412, 418 and any other unillustrated BN layers of the plurality of basic neural network blocks 410a-410n (collectively referred to as a “plurality of BN layers below”). For example, a drift of the neural network architecture 400 is based on a neural network process that is executed based on the input data 402, training parameters (e.g., a scale parameter and a shift parameter) associated with the plurality of BN layers of the neural network architecture 400, population data (e.g., a moving mean and moving standard deviation) of the plurality of BN layers, input vectors and output vectors of the plurality of BN layers. It is worth noting that each of the plurality of BN layers may include different training parameters and population data.

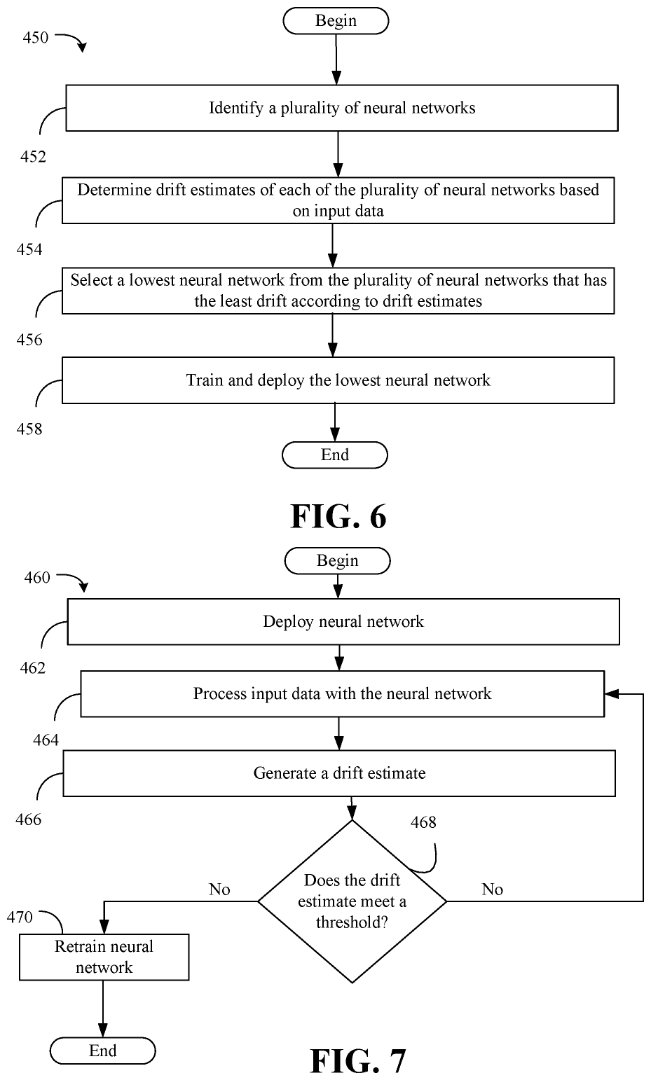

FIG. 6 shows a method 450 of selecting a neural network for deployment. The method 450 may be readily combinable with any of the embodiments described herein. For example, the method 450 may implement and/or operate in conjunction with one or more aspects of the process 100 (FIG. 1), the method 320 (FIG. 2), process 300 (FIG. 3), process 350 (FIG. 4) and/or neural network architecture 400 (FIG. 5) already discussed. More particularly, the method 450 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 452 identifies a plurality of neural networks. Illustrated processing block 454 determines drift estimates of each of the plurality of neural networks based on input data. That is, each of the neural networks processes the input data and generates a corresponding drift estimate. Illustrated processing block 456 selects a lowest neural network from the plurality of neural networks that has the least drift according to the drift estimates (e.g., a smallest drift estimate). That is, block 456 selects the neural networks that was trained data that most resembles (e.g., closest distribution) to the input data. Illustrated processing block 458 trains and deploys the lowest neural network.

FIG. 7 shows a method 460 of retraining a deployed neural network. The method 460 may be readily combinable with any of the embodiments described herein. For example, the method 460 may implement and/or operate in conjunction with one or more aspects of the process 100 (FIG. 1), the method 320 (FIG. 2), process 300 (FIG. 3), process 350 (FIG. 4), neural network architecture 400 (FIG. 5) and/or method 460 (FIG. 6) already discussed. More particularly, the method 460 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 462 deploys a neural network. Illustrated processing block 464 processes input data with the neural network. Illustrated processing block 466 generates a drift estimate of the neural network. Illustrated processing block 468 generates determines if the drift estimate meets a threshold. If so, illustrated processing block 470 retrains the neural network. Otherwise, block 468 executes again.

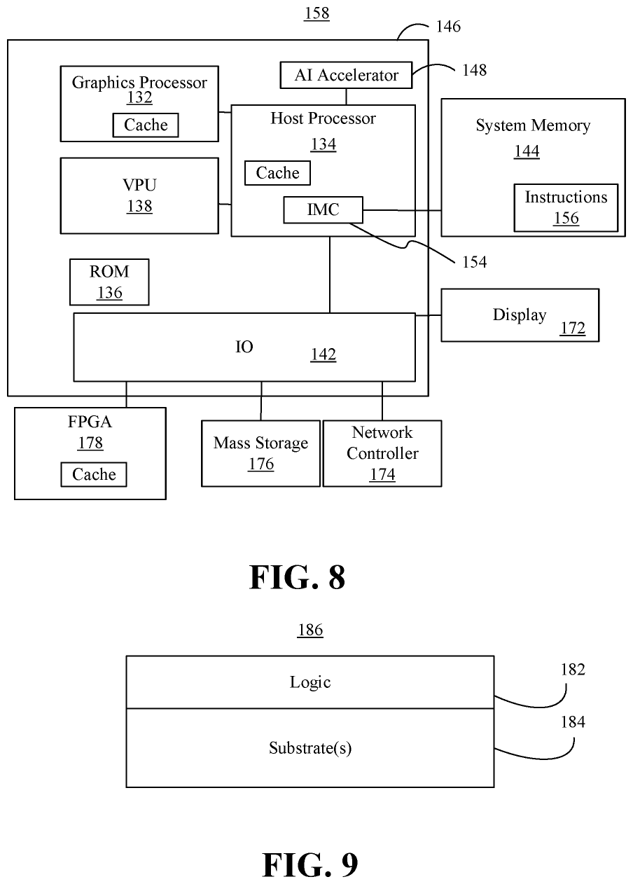

Turning now to FIG. 8, a performance enhanced computing system 158 is shown. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the computing system 158 includes a host processor 134 (e.g., CPU) having an integrated memory controller (IMC) 154 that is coupled to a system memory 144.

The illustrated computing system 158 also includes an input output (IO) module 142 implemented together with the host processor 134, a graphics processor 132 (e.g., GPU), ROM 136, and AI accelerator 148 on a semiconductor die 146 as a system on chip (SoC). The illustrated IO module 142 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). Furthermore, the SoC 146 may further include processors (not shown) and/or the AI accelerator 148 dedicated to artificial intelligence (AI) and/or neural network (NN) processing. For example, the system SoC 146 may include a vision processing unit (VPU) 138 and/or other AI/NN-specific processors such as AI accelerator 148, etc. In some embodiments, any aspect of the embodiments described herein may be implemented in the processors and/or accelerators dedicated to AI and/or NN processing such as AI accelerator 148, the graphics processor 132, VPU 138 and/or the host processor 134.

The graphics processor 132 and/or the host processor 134 may execute instructions 156 retrieved from the system memory 144 (e.g., a dynamic random-access memory) and/or the mass storage 176 to implement aspects as described herein. For example, the graphics processor 132 and/or the host processor 134 may identify an AI model (e.g., a high-level code) for execution. The AI model may be a neural network that includes BN layers. The computing system 158 may identify a first neural network, where the first neural network is associated with a first training parameter and first population data that are generated during a process to train the first neural network. The computing system 158 may execute a first neural network process to serve input data with the first neural network, and estimate a first drift of the first neural network based on the first neural network process, the first training parameter and the first population data.

When the instructions 156 are executed, the computing system 158 may implement one or more aspects of the embodiments described herein. For example, the computing system 158 may implement one or more aspects of the process 100 (FIG. 1), the method 320 (FIG. 2), process 300 (FIG. 3), process 350 (FIG. 4), neural network architecture v400 (FIG. 5), method 450 (FIG. 6) and/or method 460 (FIG. 7). The illustrated computing system 158 is therefore considered to be performance-enhanced at least to the extent that it enables the computing system 158 to determine drift estimates based on neural network processes and without reference to labeled data.

FIG. 9 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein, for example, one or more aspects of the process 100 (FIG. 1), the method 320 (FIG. 2), process 300 (FIG. 3), process 350 (FIG. 4), neural network architecture 400 (FIG. 5), method 450 (FIG. 5) and/or method 460 (FIG. 6). The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

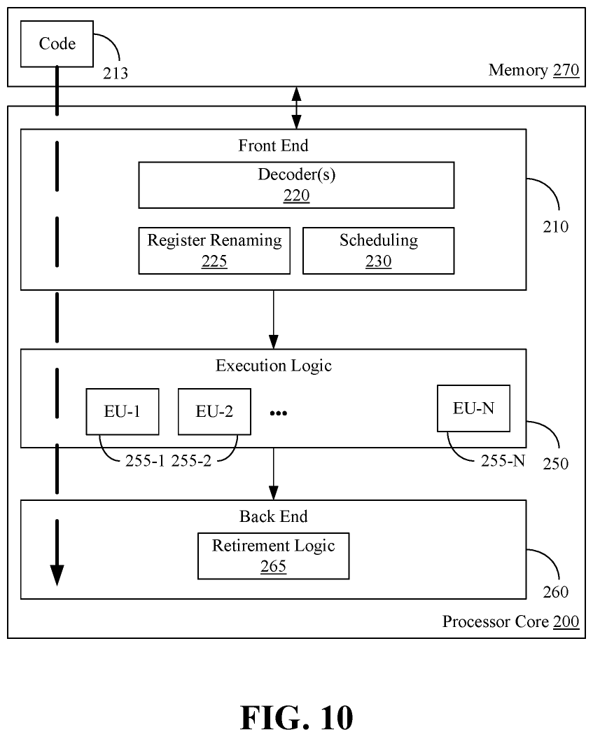

FIG. 10 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 10, a processing element may alternatively include more than one of the processor core 200 illustrated in FIG. 10. The processor core 200 may be a single-threaded core or, for at least one embodiment, the processor core 200 may be multithreaded in that it may include more than one hardware thread context (or “logical processor”) per core.

FIG. 10 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the process 100 (FIG. 1), the method 320 (FIG. 2), process 300 (FIG. 3), process 350 (FIG. 4), neural network architecture 400 (FIG. 5), method 450 (FIG. 5) and/or method 460 (FIG. 6) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 10, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

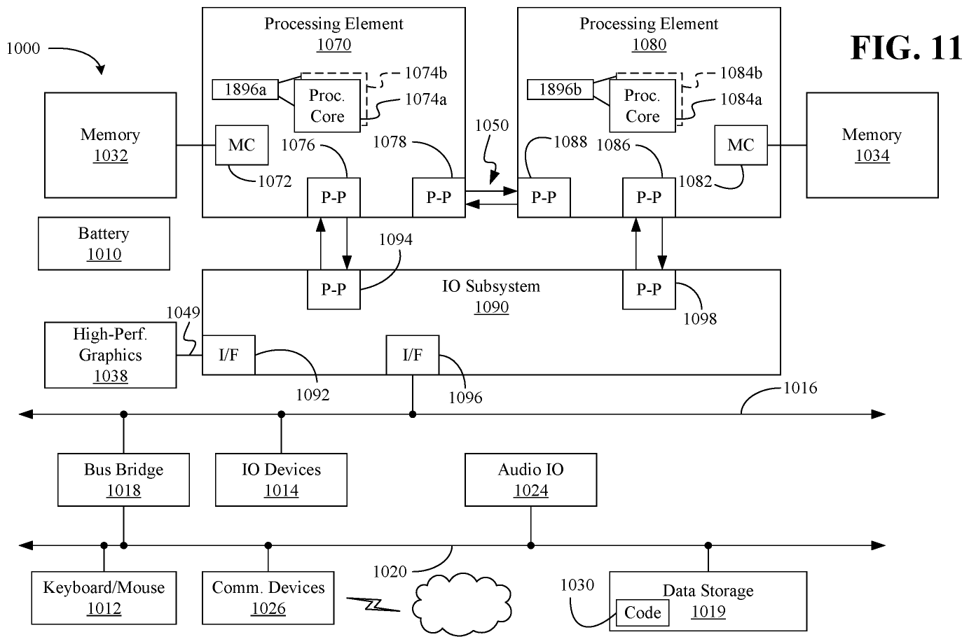

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of the process 100 (FIG. 1), the method 320 (FIG. 2), process 300 (FIG. 3), process 350 (FIG. 4), neural network architecture 400 (FIG. 5), method 450 (FIG. 5) and/or method 460 (FIG. 6), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### Additional Notes and Examples

Example 1 includes a computing system comprising a network controller to communicate with edge nodes, a processor coupled to the network controller, and a memory coupled to the processor, the memory including a set of executable program instructions, which when executed by the processor, cause the computing system to identify a first neural network, wherein the first neural network is associated with a first training parameter and first population data that are generated during a process to train the first neural network, execute a first neural network process to serve input data with the first neural network, and estimate a first drift of the first neural network based on the first neural network process, the first training parameter and the first population data to determine whether to retrain the first neural network.

Example 2 includes the computing system of claim 1, wherein the executable program instructions, when executed, cause the computing system to determine a plurality of distances for a plurality of layers of the first neural network based on the first neural network process, the first training parameter and the first population data, and estimate the first drift based on the plurality of distances.

Example 3 includes the computing system of any one of claims 1 to 2, wherein the executable program instructions, when executed, cause the computing system to identify a second neural network, wherein the second neural network is associated with a second training parameter and second population data that are generated during a process to train the second neural network, execute a second neural network process to serve the input data with the second neural network, estimate a second drift of the second neural network based on the second neural network process, the second training parameter and the second population data, and select one of the first neural network and the second neural network for deployment based on the first drift and the second drift.

Example 4 includes the computing system of claim 1, wherein the executable program instructions, when executed, cause the computing system to determine whether to retrain the first neural network based on a comparison of the first drift to a threshold.

Example 5 includes the computing system of any one of claims 1 to 4, wherein the first neural network includes a plurality of batch normalization layers, the first training parameter is to include a scale parameter and a shift parameter associated with the plurality of batch normalization layers, wherein the scale parameter and the shift parameter are generated during the process to train the first neural network, and the first population data is to include a moving mean and moving standard deviation generated during the process to train the first neural network.

Example 6 includes the computing system of any one of claims 1 to 5, wherein the executable program instructions, when executed, cause the computing system to estimate the first drift of the first neural network based on an input vector into a batch normalization layer of the first neural network and an output vector of the batch normalization layer.

Example 7 includes a semiconductor apparatus comprising one or more substrates, and logic coupled to the one or more substrates, wherein the logic is implemented in one or more of configurable or fixed-functionality hardware, the logic to identify a first neural network, wherein the first neural network is associated with a first training parameter and first population data that are generated during a process to train the first neural network, execute a first neural network process to serve input data with the first neural network, and estimate a first drift of the first neural network based on the first neural network process, the first training parameter and the first population data to determine whether to retrain the first neural network.

Example 8 includes the apparatus of claim 7, wherein the logic coupled to the one or more substrates is to determine a plurality of distances for a plurality of layers of the first neural network based on the first neural network process, the first training parameter and the first population data, and estimate the first drift based on the plurality of distances.

Example 9 includes the apparatus of any one of claims 7 to 8, wherein the logic coupled to the one or more substrates is to identify a second neural network, wherein the second neural network is associated with a second training parameter and second population data that are generated during a process to train the second neural network, execute a second neural network process to serve the input data with the second neural network, estimate a second drift of the second neural network based on the second neural network process, the second training parameter and the second population data, and select one of the first neural network and the second neural network for deployment based on the first drift and the second drift.

Example 10 includes the apparatus of claim 7, wherein the logic coupled to the one or more substrates is to determine whether to retrain the first neural network based on a comparison of the first drift to a threshold.

Example 11 includes the apparatus of any one of claims 7 to 10, wherein the first neural network includes a plurality of batch normalization layers, the first training parameter is to include a scale parameter and a shift parameter associated with the plurality of batch normalization layers, wherein the scale parameter and the shift parameter are generated during the process to train the first neural network, and the first population data is to include a moving mean and moving standard deviation generated during the process to train the first neural network.

Example 12 includes the apparatus of any one of claims 7 to 11, wherein the logic coupled to the one or more substrates is to estimate the first drift of the first neural network based on an input vector into a batch normalization layer of the first neural network and an output vector of the batch normalization layer.

Example 13 includes the apparatus of any one of claims 7 to 12, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to identify a first neural network, wherein the first neural network is associated with a first training parameter and first population data that are generated during a process to train the first neural network, execute a first neural network process to serve input data with the first neural network, and estimate a first drift of the first neural network based on the first neural network process, the first training parameter and the first population data to determine whether to retrain the first neural network.

Example 15 includes the at least one computer readable storage medium of claim 14, wherein the instructions, when executed, further cause the computing system to determine a plurality of distances for a plurality of layers of the first neural network based on the first neural network process, the first training parameter and the first population data, and estimate the first drift based on the plurality of distances.

Example 16 includes the at least one computer readable storage medium of any one of claims 14 to 15, wherein the instructions, when executed, further cause the computing system to identify a second neural network, wherein the second neural network is associated with a second training parameter and second population data that are generated during a process to train the second neural network, execute a second neural network process to serve the input data with the second neural network, estimate a second drift of the second neural network based on the second neural network process, the second training parameter and the second population data, and select one of the first neural network and the second neural network for deployment based on the first drift and the second drift.

Example 17 includes the at least one computer readable storage medium of claim 14, wherein the instructions, when executed, further cause the computing system to determine whether to retrain the first neural network based on a comparison of the first drift to a threshold.

Example 18 includes the at least one computer readable storage medium of any one of claims 14 to 17, wherein the first neural network includes a plurality of batch normalization layers, the first training parameter is to include a scale parameter and a shift parameter associated with the plurality of batch normalization layers, wherein the scale parameter and the shift parameter are generated during the process to train the first neural network, and the first population data is to include a moving mean and moving standard deviation generated during the process to train the first neural network.

Example 19 includes the at least one computer readable storage medium of any one of claims 14 to 18, wherein the instructions, when executed, further cause the computing system to estimate the first drift of the first neural network based on an input vector into a batch normalization layer of the first neural network and an output vector of the batch normalization layer.

Example 20 includes a method comprising identifying a first neural network, wherein the first neural network is associated with a first training parameter and first population data that are generated during a process to train the first neural network, executing a first neural network process to serve input data with the first neural network, and estimating a first drift of the first neural network based on the first neural network process, the first training parameter and the first population data to determine whether to retrain the first neural network.

Example 21 includes the method of claim 20, further comprising determining a plurality of distances for a plurality of layers of the first neural network based on the first neural network process, the first training parameter and the first population data, and estimating the first drift based on the plurality of distances.

Example 22 includes the method of any one of claims 20 to 21, further comprising identifying a second neural network, wherein the second neural network is associated with a second training parameter and second population data that are generated during a process to train the second neural network, executing a second neural network process to serve the input data with the second neural network, estimating a second drift of the second neural network based on the second neural network process, the second training parameter and the second population data, and selecting one of the first neural network and the second neural network for deployment based on the first drift and the second drift.

Example 23 includes the method of claim 20, further comprising determining whether to retrain the first neural network based on a comparison of the first drift to a threshold.

Example 24 includes the method of any one of claims 20 to 23, wherein the first neural network includes a plurality of batch normalization layers, the first training parameter includes a scale parameter and a shift parameter associated with the plurality of batch normalization layers, wherein the scale parameter and the shift parameter are generated during the process to train the first neural network, and the first population data includes a moving mean and moving standard deviation generated during the process to train the first neural network.

Example 25 includes the method of any one of claims 20 to 24, further comprising estimating the first drift of the first neural network based on an input vector into a batch normalization layer of the first neural network and an output vector of the batch normalization layer.

Example 26 includes an apparatus comprising means for identifying a first neural network, wherein the first neural network is to be associated with a first training parameter and first population data that are generated during a process to train the first neural network, means for executing a first neural network process to serve input data with the first neural network, and means for estimating a first drift of the first neural network based on the first neural network process, the first training parameter and the first population data to determine whether to retrain the first neural network.

Example 27 includes the apparatus of claim 26, further comprising means for determining a plurality of distances for a plurality of layers of the first neural network based on the first neural network process, the first training parameter and the first population data, and means for estimating the first drift based on the plurality of distances.

Example 28 includes the apparatus of any one of claims 26 to 27, further comprising means for identifying a second neural network, wherein the second neural network is associated with a second training parameter and second population data that are generated during a process to train the second neural network, means for executing a second neural network process to serve the input data with the second neural network, means for estimating a second drift of the second neural network based on the second neural network process, the second training parameter and the second population data, and means for selecting one of the first neural network and the second neural network for deployment based on the first drift and the second drift.

Example 29 includes the apparatus of claim 26, further comprising means for determining whether to retrain the first neural network based on a comparison of the first drift to a threshold.

Example 30 includes the apparatus of any one of claims 26 to 29, wherein the first neural network includes a plurality of batch normalization layers, the first training parameter includes a scale parameter and a shift parameter associated with the plurality of batch normalization layers, wherein the scale parameter and the shift parameter are generated during the process to train the first neural network, and the first population data includes a moving mean and moving standard deviation generated during the process to train the first neural network.

Example 31 incudes the apparatus of any one of claims 26 to 30, further comprising means for estimating the first drift of the first neural network based on an input vector into a batch normalization layer of the first neural network and an output vector of the batch normalization layer.

Thus, technology described herein may provide for an enhanced profiling system that enables determination of drift estimates based on unlabeled data. Embodiments as described herein may determine the drift between a training dataset that is used to train a neural network model, and an input dataset that the neural network processes.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller to communicate with edge nodes;
a processor coupled to the network controller; and
a memory coupled to the processor, the memory including a set of executable program instructions, which when executed by the processor, cause the computing system to:
identify a first neural network, wherein the first neural network is associated with a first training parameter and first population data that are generated during a process to train the first neural network;
execute a first neural network process to serve input data with the first neural network; and
estimate a first drift of the first neural network based on the first neural network process, the first training parameter and the first population data to determine whether to retrain the first neural network.

2. The computing system of claim 1, wherein the executable program instructions, when executed, cause the computing system to:
determine a plurality of distances for a plurality of layers of the first neural network based on the first neural network process, the first training parameter and the first population data; and
estimate the first drift based on the plurality of distances.

3. The computing system of claim 1, wherein the executable program instructions, when executed, cause the computing system to:
identify a second neural network, wherein the second neural network is associated with a second training parameter and second population data that are generated during a process to train the second neural network;
execute a second neural network process to serve the input data with the second neural network;
estimate a second drift of the second neural network based on the second neural network process, the second training parameter and the second population data; and
select one of the first neural network and the second neural network for deployment based on the first drift and the second drift.

4. The computing system of claim 1, wherein the executable program instructions, when executed, cause the computing system to:
determine whether to retrain the first neural network based on a comparison of the first drift to a threshold.

5. The computing system of claim 1, wherein:
the first neural network includes a plurality of batch normalization layers;
the first training parameter is to include a scale parameter and a shift parameter associated with the plurality of batch normalization layers, wherein the scale parameter and the shift parameter are generated during the process to train the first neural network; and
the first population data is to include a moving mean and moving standard deviation generated during the process to train the first neural network.

6. The computing system of claim 1, wherein the executable program instructions, when executed, cause the computing system to:
estimate the first drift of the first neural network based on an input vector into a batch normalization layer of the first neural network and an output vector of the batch normalization layer.

7. A semiconductor apparatus comprising:
one or more substrates; and
logic coupled to the one or more substrates, wherein the logic is implemented in one or more of configurable or fixed-functionality hardware, the logic to:
identify a first neural network, wherein the first neural network is associated with a first training parameter and first population data that are generated during a process to train the first neural network;
execute a first neural network process to serve input data with the first neural network; and
estimate a first drift of the first neural network based on the first neural network process, the first training parameter and the first population data to determine whether to retrain the first neural network.

8. The apparatus of claim 7, wherein the logic coupled to the one or more substrates is to:
determine a plurality of distances for a plurality of layers of the first neural network based on the first neural network process, the first training parameter and the first population data; and
estimate the first drift based on the plurality of distances.

9. The apparatus of claim 7, wherein the logic coupled to the one or more substrates is to:
identify a second neural network, wherein the second neural network is associated with a second training parameter and second population data that are generated during a process to train the second neural network;
execute a second neural network process to serve the input data with the second neural network;
estimate a second drift of the second neural network based on the second neural network process, the second training parameter and the second population data; and
select one of the first neural network and the second neural network for deployment based on the first drift and the second drift.

10. The apparatus of claim 7, wherein the logic coupled to the one or more substrates is to:
determine whether to retrain the first neural network based on a comparison of the first drift to a threshold.

11. The apparatus of claim 7, wherein:
the first neural network includes a plurality of batch normalization layers;
the first training parameter is to include a scale parameter and a shift parameter associated with the plurality of batch normalization layers, wherein the scale parameter and the shift parameter are generated during the process to train the first neural network; and
the first population data is to include a moving mean and moving standard deviation generated during the process to train the first neural network.

12. The apparatus of claim 7, wherein the logic coupled to the one or more substrates is to:
estimate the first drift of the first neural network based on an input vector into a batch normalization layer of the first neural network and an output vector of the batch normalization layer.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
identify a first neural network, wherein the first neural network is associated with a first training parameter and first population data that are generated during a process to train the first neural network;
execute a first neural network process to serve input data with the first neural network; and
estimate a first drift of the first neural network based on the first neural network process, the first training parameter and the first population data to determine whether to retrain the first neural network.

15. The at least one computer readable storage medium of claim 14, wherein the instructions, when executed, further cause the computing system to:
determine a plurality of distances for a plurality of layers of the first neural network based on the first neural network process, the first training parameter and the first population data; and
estimate the first drift based on the plurality of distances.

16. The at least one computer readable storage medium of claim 14, wherein the instructions, when executed, further cause the computing system to:
identify a second neural network, wherein the second neural network is associated with a second training parameter and second population data that are generated during a process to train the second neural network;
execute a second neural network process to serve the input data with the second neural network;
estimate a second drift of the second neural network based on the second neural network process, the second training parameter and the second population data; and
select one of the first neural network and the second neural network for deployment based on the first drift and the second drift.

17. The at least one computer readable storage medium of claim 14, wherein the instructions, when executed, further cause the computing system to:
determine whether to retrain the first neural network based on a comparison of the first drift to a threshold.

18. The at least one computer readable storage medium of claim 14, wherein:
the first neural network includes a plurality of batch normalization layers;
the first training parameter is to include a scale parameter and a shift parameter associated with the plurality of batch normalization layers, wherein the scale parameter and the shift parameter are generated during the process to train the first neural network; and
the first population data is to include a moving mean and moving standard deviation generated during the process to train the first neural network.

19. The at least one computer readable storage medium of claim 14, wherein the instructions, when executed, further cause the computing system to:
estimate the first drift of the first neural network based on an input vector into a batch normalization layer of the first neural network and an output vector of the batch normalization layer.

20. A method comprising:
identifying a first neural network, wherein the first neural network is associated with a first training parameter and first population data that are generated during a process to train the first neural network;
executing a first neural network process to serve input data with the first neural network; and
estimating a first drift of the first neural network based on the first neural network process, the first training parameter and the first population data to determine whether to retrain the first neural network.

21. The method of claim 20, further comprising:
determining a plurality of distances for a plurality of layers of the first neural network based on the first neural network process, the first training parameter and the first population data; and
estimating the first drift based on the plurality of distances.

22. The method of claim 20, further comprising:
identifying a second neural network, wherein the second neural network is associated with a second training parameter and second population data that are generated during a process to train the second neural network;
executing a second neural network process to serve the input data with the second neural network;
estimating a second drift of the second neural network based on the second neural network process, the second training parameter and the second population data; and
selecting one of the first neural network and the second neural network for deployment based on the first drift and the second drift.

23. The method of claim 20, further comprising:
determining whether to retrain the first neural network based on a comparison of the first drift to a threshold.

24. The method of claim 20, wherein:
the first neural network includes a plurality of batch normalization layers;
the first training parameter includes a scale parameter and a shift parameter associated with the plurality of batch normalization layers, wherein the scale parameter and the shift parameter are generated during the process to train the first neural network; and
the first population data includes a moving mean and moving standard deviation generated during the process to train the first neural network.

25. The method of claim 20, further comprising:
estimating the first drift of the first neural network based on an input vector into a batch normalization layer of the first neural network and an output vector of the batch normalization layer.
